(19) United States
(12) Patent Application Publication
(10) Pub. No.: US 2026/0170368 A1
(43) Pub. Date: Jun. 18, 2026

(54) FACTOR ANALYSIS DEVICE, FACTOR ANALYSIS METHOD, AND NON-TRANSITORY COMPUTER-READABLE STORAGE MEDIUM

(71) Applicant: Mitsubishi Electric Corporation, Tokyo (JP)

(72) Inventor: Takeru MORIYAMA, Tokyo (JP)

(73) Assignee: Mitsubishi Electric Corporation, Tokyo (JP)

(21) Appl. No.: 19/530,562

(22) Filed: Feb. 5, 2026

Related U.S. Application Data
(63) Continuation of application No. PCT/JP2023/033275, filed on Sep. 13, 2023.

(51) Int. Cl. G06N 5/045

(52) U.S. Cl. CPC G06N 5/045

(57) ABSTRACT

A factor analysis device includes a data acquiring unit to acquire a plurality of types of monitoring data related to a monitoring target, a variable setting unit to generate learning monitoring data, factor analysis monitoring data, a learning data set including an explanatory variable and an objective variable, and a factor analysis data set on the basis of the monitoring data, a model learning unit to generate a learning model, a contribution degree calculating unit to calculate a contribution degree that is a degree of influence of the explanatory variable on the objective variable on the basis of causal relationship data indicating a causal relationship in the plurality of types of monitoring data, the learning model, the learning monitoring data, and the factor analysis monitoring data, and a factor analysis unit to calculate a factor degree, a factor analysis result output unit to output a factor analysis result.

### CROSS REFERENCE TO RELATED APPLICATION

This application is a Continuation of PCT International Application No. PCT/JP2023/033275, filed on Sep. 13, 2023, which is hereby expressly incorporated by reference into the present application.

### TECHNICAL FIELD

The present disclosure relates to a factor analysis technique.

### BACKGROUND ART

In order to achieve a desirable result in an event requiring solution to a problem, it is important to take appropriate measures for the problem of the event. For example, in equipment of a plant or a factory, it is important to take appropriate measures or operations against a factor that lowers productivity or efficiency in response to a need to improve productivity or efficiency of the equipment. As described above, in order to solve the problem, it is necessary to identify the problem of the event, but the event is often a result of overlapping of a plurality of conditions and it is not easy to identify the problem. Accordingly, there is conventionally known a factor analysis technique capable of quantitatively analyzing a relationship between the event (objective variable) and candidates (explanatory variables) for some problems considered to be related to the event using a learning model.

Patent Literature 1 describes “a quality variation factor of a product” “is extracted” and “a defect factor analysis method and a defect factor analysis device” by “using a machine-learned learning model”.

Specifically, the “defect factor analysis method and defect factor analysis device” of Patent Literature 1 “causes a computer to execute: a step of acquiring a plurality of pieces of manufacturing condition data or a plurality of pieces of monitoring data obtained by monitoring an operation of a manufacturing facility; a step of predicting a quality of a product to be manufactured by inputting the acquired plurality of pieces of manufacturing condition data or monitoring data to a learning model learned to output quality data indicating the quality of the product manufactured in the manufacturing facility when the plurality of pieces of manufacturing condition data or monitoring data is input; and a step of calculating a degree of contribution of each of the plurality of pieces of manufacturing condition data or monitoring data to quality data or anomaly score data output from the learning model using the learning model” (Patent Literature 1: Abstract, Solution).

According to the “defect factor analysis method and defect factor analysis device” of Patent Literature 1, the degree of contribution indicating the degree of direct contribution for each factor (explanatory variable in the learning model) to the product quality (objective variable in the learning model) is calculated.

### CITATION LIST

### Patent Literature

Patent Literature 1: JP 2022-043848 A

### SUMMARY OF INVENTION

### Technical Problem

A plurality of factors may have dependence relationship in such a manner that one factor affects another factor.

In the conventional technique, when a plurality of factors (explanatory variables) has a dependence relationship, indirect contribution based on the dependence relationship is not accounted for, and a wrong analysis result is presented on the basis of a wrong contribution degree.

Such a conventional technique has a problem that it is difficult to improve the accuracy of factor analysis.

The present disclosure has been made to solve the above problems, and an object thereof is to improve accuracy of factor analysis.

### Solution to Problem

A factor analysis device of the present disclosure includes:
processing circuitry
to acquire a plurality of types of monitoring data related to a monitoring target;
to generate learning monitoring data, factor analysis monitoring data, a learning data set including an explanatory variable and an objective variable, and a factor analysis data set on the basis of the monitoring data;
to generate a learning model learned in such a manner as to receive an input of the explanatory variable and output the objective variable on the basis of the learning data set;
to calculate a contribution degree that is a degree of influence of the explanatory variable on the objective variable on the basis of causal relationship data indicating a causal relationship in the plurality of types of monitoring data, the learning model, the learning monitoring data, and the factor analysis monitoring data;
to calculate a factor degree that is a degree of being a factor for each of the explanatory variables on the basis of the contribution degree; and
to output a factor analysis result on the basis of the factor analysis data set, the contribution degree, and the factor degree.

### Advantageous Effects of Invention

According to the present disclosure, there is an effect that accuracy of factor analysis can be improved.

### BRIEF DESCRIPTION OF DRAWINGS

FIG. 1 is a diagram illustrating a configuration example of a factor analysis device 100 according to a first embodiment of the present disclosure.

FIG. 2 is a diagram illustrating a configuration example of a factor analysis system 10 including a factor analysis device 100A according to the first embodiment of the present disclosure.

FIG. 3 is a flowchart illustrating an example of processing of the factor analysis device 100 or 100A of the present disclosure.

FIG. 4 is a diagram illustrating a first example of causal relationship data used in the factor analysis device 100 or 100A of the present disclosure.

FIG. 5 is a diagram illustrating a second example of the causal relationship data used in the factor analysis device 100 or 100A of the present disclosure.

FIG. 6 is a diagram illustrating a third example of the causal relationship data used in the factor analysis device 100 or 100A of the present disclosure.

FIG. 7 is a diagram describing a degree of contribution output by a contribution degree calculating unit 150 or 150A in the factor analysis device 100 or 100A of the present disclosure.

FIG. 8 is a diagram describing a factor degree output by a factor analysis unit 160 or 160A in the factor analysis device 100 or 100A of the present disclosure.

FIG. 9 is a diagram illustrating a first display example of a factor analysis result output by a factor analysis result output unit 170 or 170A in the factor analysis device 100 or 100A of the present disclosure.

FIG. 10 is a diagram illustrating a second display example of the factor analysis result output by the factor analysis result output unit 170 or 170A in the factor analysis device 100 or 100A of the present disclosure.

FIG. 11 is a diagram illustrating a configuration example of a factor analysis system 10 including a factor analysis device 100B according to a second embodiment of the present disclosure.

FIG. 12 is a diagram illustrating a display example of a factor analysis result output by a factor analysis result output unit 170B in the factor analysis device 100B according to the second embodiment of the present disclosure.

FIG. 13 is a diagram illustrating a configuration example of a factor analysis system 10 including a factor analysis device 100C according to a third embodiment of the present disclosure.

FIG. 14 is a diagram illustrating aggregation conditions used in the factor analysis device 100C according to the third embodiment of the present disclosure.

FIG. 15 is a diagram illustrating a configuration example of a factor analysis system 10 including a factor analysis device 100D according to a fourth embodiment of the present disclosure.

FIG. 16 is a diagram illustrating a first display example of a factor analysis result output by a factor analysis result output unit 170B in the factor analysis device 100D according to the fourth embodiment of the present disclosure.

FIG. 17 is a diagram illustrating a second display example of the factor analysis result output by the factor analysis result output unit 170B in the factor analysis device 100D according to the fourth embodiment of the present disclosure.

FIG. 18 is a diagram illustrating a first example of a hardware configuration for implementing the functions according to the present disclosure.

FIG. 19 is a diagram illustrating a second example of a hardware configuration for implementing the functions according to the present disclosure.

### DESCRIPTION OF EMBODIMENTS

Hereinafter, in order to describe the present disclosure in more detail, embodiments of the present disclosure will be described with reference to the accompanying drawings.

The present disclosure illustrates a technique for estimating an influence of an explanatory variable on an objective variable with higher accuracy than the prior art by using causal relationship data such as a causal graph.

### First Embodiment

A first embodiment describes a basic configuration of a factor analysis device according to the present disclosure.

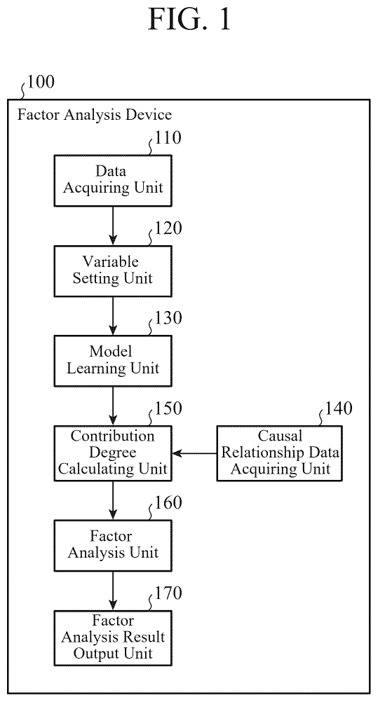

FIG. 1 is a diagram illustrating a configuration example of a factor analysis device 100 according to the first embodiment of the present disclosure.

The factor analysis device 100 quantifies the magnitude of the influence of monitoring data on a target using a causal graph (causal relationship data) regarding a causal relationship or dependence relationship between an objective variable that is each target value and an explanatory variable that is monitoring data.

The factor analysis device 100 includes a data acquiring unit 110, a variable setting unit 120, a model learning unit 130, a causal relationship data acquiring unit 140, a contribution degree calculating unit 150, a factor analysis unit 160, and a factor analysis result output unit 170.

The data acquiring unit 110 acquires a plurality of types of monitoring data related to a monitoring target.

The variable setting unit 120 generates learning monitoring data, factor analysis monitoring data, a learning data set, and a factor analysis data set on the basis of the monitoring data.

The learning data set is a data set including an explanatory variable and an objective variable.

On the basis of the learning data set, the model learning unit 130 generates a learning model learned in such a manner as to receive an input of the explanatory variable and output the objective variable.

The causal relationship data acquiring unit 140 acquires causal relationship data indicating a causal relationship in a plurality of types of monitoring data.

The contribution degree calculating unit 150 calculates a contribution degree, which is a degree of influence of the explanatory variable on the objective variable, on the basis of the causal relationship data indicating the causal relationship in the plurality of types of monitoring data, the learning model, the learning monitoring data, and the factor analysis monitoring data.

On the basis of the contribution degree, the factor analysis unit 160 calculates a factor degree that is a degree of being a factor for each of the explanatory variables.

The factor analysis result output unit 170 outputs a factor analysis result on the basis of the factor analysis data set, the contribution degree, and the factor degree.

The factor analysis device 100 is used for, for example, various production facilities that consume any resource such as power, gas, and oil in a factory.

Note that the monitoring data is collected from a sensor provided in the production facility and is collected by monitoring the production facility.

For example, the factor analysis device 100 collects monitoring data obtained by monitoring a production facility to be analyzed, that is, a production facility to be improved in resource consumption efficiency and productivity.

The monitoring data includes sensor data such as resource consumption, temperature, and humidity collected by sensors provided in the facility, and production management information such as product quality, production quantity, work time, worker, and production conditions.

From the monitoring data, one or more pieces of data representing consumption efficiency of some resource or productivity are set as an objective variable, and two or more pieces of data associated with the objective variable, that is, considered as candidates for a factor that fluctuates the objective variable are set as explanatory variables.

The factor analysis device 100 causes the learning model to learn in such a manner as to receive an input of the explanatory variable and output the objective variable.

On the basis of the learning model, the monitoring data, and the causal graph between the monitoring data, the factor analysis device 100 calculates the degree of influence of the explanatory variable on the objective variable, that is, “contribution of factors that fluctuate resource consumption efficiency and productivity” for each data sample and explanatory variable.

The factor analysis device 100 aggregates the contribution degree and calculates the factor degree for each explanatory variable.

The factor analysis device 100 estimates a factor that fluctuates resource consumption efficiency and productivity, and presents information regarding an analysis result to a user such as an operator including a site maintenance worker or a resource manager of a target facility.

Thus, the factor analysis device 100 can support work for improving resource consumption efficiency and productivity by the operator, and reduce the load on the operator.

A form of a factor analysis system including the factor analysis device 100 will be described.

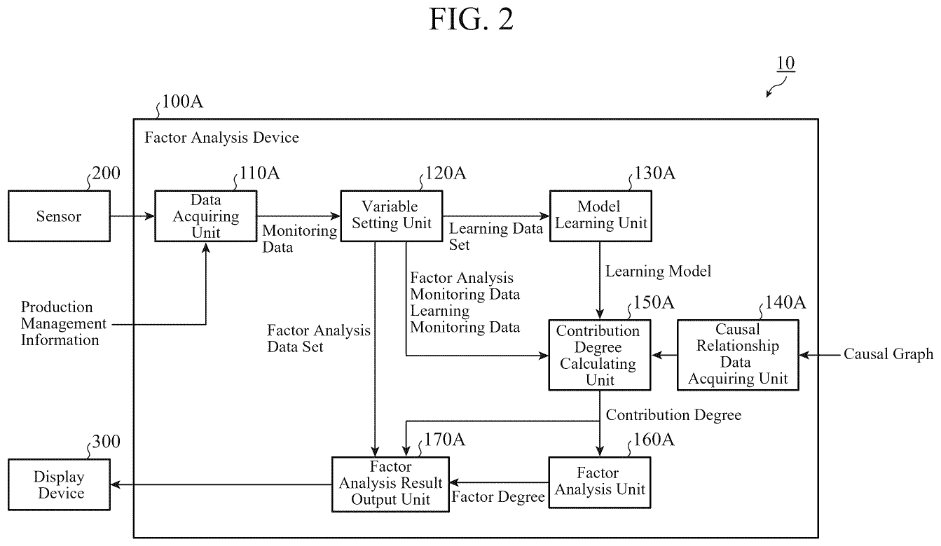

FIG. 2 is a diagram illustrating a configuration example of a factor analysis system 10 including a factor analysis device 100A according to the first embodiment of the present disclosure.

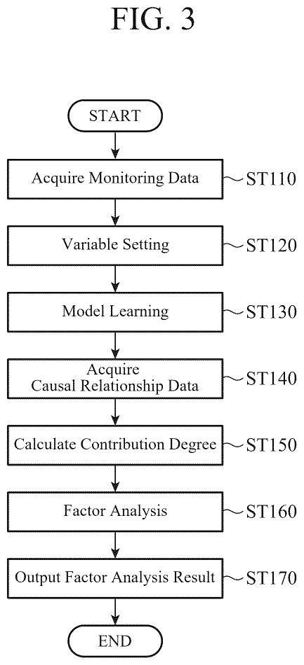

FIG. 3 is a flowchart illustrating an example of processing of the factor analysis device 100 or 100A of the present disclosure.

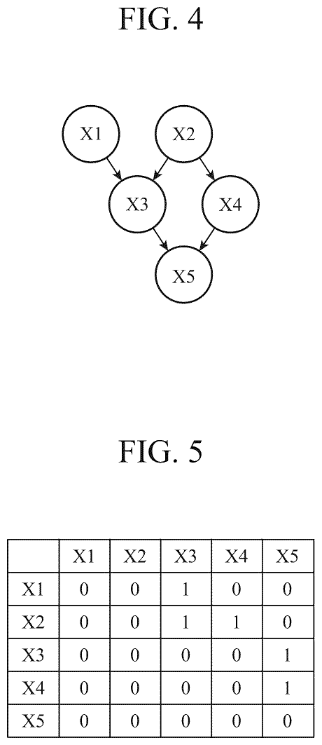

FIG. 4 is a diagram illustrating a first example of causal relationship data used in the factor analysis device 100 or 100A of the present disclosure.

FIG. 5 is a diagram illustrating a second example of the causal relationship data used in the factor analysis device 100 or 100A of the present disclosure.

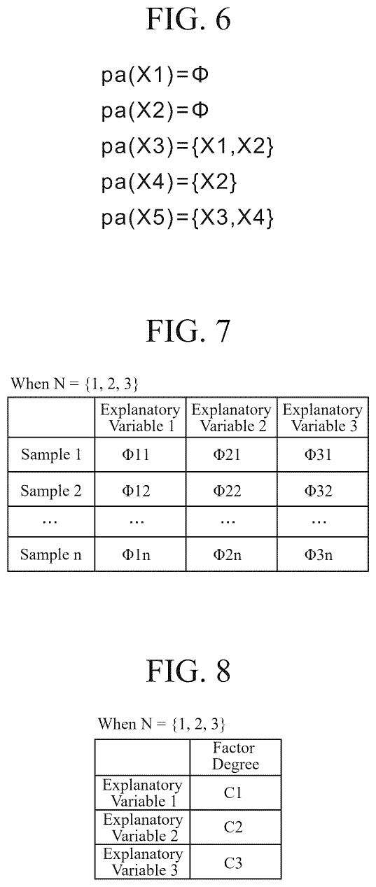

FIG. 6 is a diagram illustrating a third example of the causal relationship data used in the factor analysis device 100 or 100A of the present disclosure.

The factor analysis system 10 includes the factor analysis device 100A, a sensor 200, and a display device 300.

The factor analysis device 100A quantifies the magnitude of the influence of monitoring data on a target value using a causal graph (causal relationship data) regarding a causal relationship or dependence relationship between each target value (objective variable) and monitoring data (explanatory variable), thereby supporting consideration of measures for improving resource consumption efficiency and productivity and prioritization.

The sensor 200 is provided in a production facility that is a monitoring target facility. The sensor 200 outputs sensor data to the factor analysis device 100.

The sensor data is, for example, time-series data of sensor measurement values for a predetermined time obtained at predetermined intervals by the sensor 200 provided in the target facility.

The sensor data indicates, for example, sensor measurement values of at least one of temperature, humidity, electrical power, gas volume, petroleum volume, water volume, or steam flow rate.

Note that this is merely an example, and the sensor data may include a control value such as a command value or a reference value for a predetermined time obtained at predetermined intervals by the plurality of sensors 200.

The display device 300 is, for example, a display device.

The display device 300 displays a factor analysis result output by the factor analysis device 100.

The display device 300 may be an input and output device configured to include an input device. In this case, the display device 300 includes an information processing terminal or the like.

A configuration example of the factor analysis device 100 or 100A will be described.

The factor analysis device 100 or 100A includes a data acquiring unit 110 or 110A, a variable setting unit 120 or 120A, a model learning unit 130 or 130A, a causal relationship data acquiring unit 140 or 140A, a contribution degree calculating unit 150 or 150A, a factor analysis unit 160 or 160A, and a factor analysis result output unit 170 or 170A.

The data acquiring unit 110 or 110A acquires sensor data and production management information as monitoring data.

The data acquiring unit 110 or 110A acquires a plurality of types of monitoring data related to the monitoring target.

The data acquiring unit 110 or 110A acquires, as monitoring data, a plurality of pieces of time-series sensor data collected by the plurality of sensors 200 provided in a target facility and production management information related to production of the target facility.

The data acquiring unit 110 or 110A acquires sensor data from the sensors 200.

In addition, the data acquiring unit 110 or 110A acquires production management information related to production of the target facility.

The production management information is time-series data for a predetermined time obtained at predetermined intervals.

The production management information is, for example, data of at least one of production conditions (production speed, product replacement, worker, and the like), a production quantity, or a work time (value production time, malfunction handling time, set-up time, or the like) related to production.

The sensor data and the production management information are acquired as monitoring data.

That is, the data acquiring unit 110 or 110A acquires, as monitoring data, a plurality of pieces of time-series sensor data collected by a plurality of sensors provided in the monitoring target facility and production management information related to production of the monitoring target facility.

Here, when the sampling period differs depending on the data, resampling processing may be performed on the basis of the longest sampling period among the monitoring data.

For example, assuming that the quantity of monitoring data is represented by n, the monitoring data is represented by X1, X2, X3, X4, . . . , and Xn. Further, assuming that data is collected at each of time 1, time 2, . . . , time t, the monitoring data is represented by a two-dimensional data frame in which a row is the number t of times and a column is the quantity n.

A value at time 1 of the first monitoring data X1 is represented by X11, a value at time 1 of the second monitoring data X2 is represented by X21, and a value at time 2 of the first monitoring data X1 is represented by X12.

The variable setting unit 120 or 120A acquires monitoring data, and generates learning monitoring data, factor analysis monitoring data, a learning data set including an explanatory variable and an objective variable, and a factor analysis data set on the basis of the monitoring data.

The variable setting unit 120 or 120A generates the learning monitoring data, the factor analysis monitoring data, the learning data set including the explanatory variable and the objective variable, and the factor analysis data set on the basis of the monitoring data.

The variable setting unit 120 or 120A sets one piece of data representing consumption efficiency of some resource or productivity as the objective variable.

Here, as the objective variable, the monitoring data selected by the user may be used as it is. For example, the variable setting unit 120 or 120A may set data indicating the quality of a product as the objective variable.

The variable setting unit 120 or 120A may use, as the objective variable, data obtained by performing preprocessing on at least one or more pieces of monitoring data selected by the user.

For example, the variable setting unit 120 or 120A may calculate a basic unit from the production quantity and the resource consumption and set the basic unit as the objective variable.

The objective variable may be discretized by one or more thresholds. (When monitoring data is continuous value, or the like)

At this time, a threshold may be manually set by the user, or a statistic such as an average value, a median value, or a standard deviation of the objective variable may be used.

Further, in the variable setting unit 120 or 120A, two or more pieces of data related to the objective variable, that is, conceivable as candidates of a factor that fluctuates the objective variable are selected from the monitoring data and set as explanatory variables by the user.

Note that the explanatory variable does not include monitoring data affected by the objective variable.

For example, in the causal graph to be described later, the variable setting unit 120 or 120A does not include the monitoring data on the result side (child, downstream) of the objective variable in the explanatory variable.

Then, the variable setting unit 120 or 120A generates a data set in which the objective variable and the explanatory variable are paired.

The variable setting unit 120 or 120A extracts a data set corresponding to a part or all of the times at which the data set is generated, and outputs the data set to the model learning unit 130 or 130A as a learning data set.

In addition, when the variable setting unit 120 or 120A extracts a data set corresponding to a part of the times as a learning data set, the variable setting unit outputs a data set corresponding to a time other than the part of the times to the factor analysis result output unit 170 or 170A as the factor analysis data set.

When all the data sets are set as learning data sets, the variable setting unit 120 or 120A outputs all the data sets to the factor analysis result output unit 170 or 170A as the factor analysis data set.

When extracting a data set corresponding to a part of the times as a learning data set, the variable setting unit 120 or 120A outputs monitoring data corresponding to the part of the times as learning monitoring data and monitoring data corresponding to a time other than the part of the times as the factor analysis monitoring data to the contribution degree calculating unit 150 or 150A.

When all the data sets are set as learning data sets, all the monitoring data are output to the contribution degree calculating unit 150 or 150A as the factor analysis monitoring data and the learning monitoring data.

The model learning unit 130 or 130A generates a model learned in such a manner as to receive an input of an explanatory variable and output an objective variable on the basis of the learning data set.

The model learning unit 130 or 130A generates a learning model on the basis of the learning data set.

Specifically, when the explanatory variable of the learning data set is input, the model learning unit 130 or 130A optimizes the parameter constituting the learning model in such a manner that a value output from the learning model approaches the objective variable of the learning data set.

The model learning unit 130 or 130A can use the following as a known learning model.

In a case where the objective variable is a continuous value, the model learning unit 130 or 130A can use, for example, a regression tree, a random forest regression, a neural network, a support vector regression, or the like.

In a case where the objective variable is a discrete value, the model learning unit 130 or 130A can use, for example, a decision tree, a random forest, a neural network, a support vector machine, or the like.

The learning model may be configured by combining at least one or more methods.

The causal relationship data acquiring unit 140 or 140A acquires causal relationship data indicating a causal relationship in a plurality of types of monitoring data.

The causal relationship data is data indicating dependence relationship between data.

The causal relationship data is data indicating a causal relationship and a dependence relationship between a plurality of types of monitoring data.

The causal relationship data indicates a causal relationship and a dependence relationship between input data that is data input to the learning model.

The causal relationship data is data manually created by a user.

Alternatively, the causal relationship data is data estimated from the monitoring data.

Alternatively, the causal relationship data is data given in advance using both data manually created by the user and data estimated from the monitoring data.

The causal relationship data is, for example, data expressed in a causal graph (FIG. 4, FIG. 5, or FIG. 6) described later.

Hereinafter, in the description, the causal relationship data is also described as a causal graph.

The contribution degree calculating unit 150 or 150A calculates a contribution degree, which is a degree of influence of the explanatory variable on the objective variable, on the basis of the causal relationship data indicating the causal relationship in the plurality of types of monitoring data, the learning model, the learning monitoring data, and the factor analysis monitoring data.

The contribution degree calculating unit 150 or 150A acquires the causal graph, the learning model, the learning monitoring data, and the factor analysis monitoring data, and calculates the contribution degree obtained by quantifying the influence of the explanatory variable on the objective variable for each data sample. Here, for example, the causal graph may be stored in advance in a causal graph storage unit, and may be output from the causal graph storage unit to the contribution degree calculating unit 150 or 150A. In a case where the contribution degree calculating unit 150 or 150A is configured to directly receive the causal graph from the causal graph storage unit, the causal relationship data acquiring unit need not be included.

The contribution degree calculating unit 150 or 150A calculates a contribution degree representing the degree of influence of the explanatory variable on the objective variable for each data sample on the basis of the input causal graph, learning model, learning monitoring data, and factor analysis monitoring data.

The contribution degree calculating unit 150 or 150A is extended to consider the causal graph in addition to the conventional contribution degree calculation method.

The contribution degree calculating unit 150 or 150A has a function of calculating the magnitude of the explanatory variable affecting the objective variable on the basis of the dependence relationship between the data indicated by the causal graph while also considering the indirect influence.

For example, explainable AI (XAI) such as SHAP value or LIME can be used as a method of quantifying the magnitude of the influence.

The contribution degree calculating unit 150 or 150A calculates the contribution degree of the explanatory variable to the objective variable using the learned learning model, the factor analysis monitoring data, the learning monitoring data, and the causal graph (causal relationship data).

The contribution degree calculated by the contribution degree calculating unit 150 or 150A is a contribution degree in which an indirect contribution is accounted for on the basis of the causal graph (causal relationship data) in addition to a direct contribution degree.

For example, the degree of contribution is a SHAP value that can be calculated using a learning model.

The SHAP value of a certain explanatory variable in a certain data sample is a value corresponding to a difference between an output value of the learning model in a case where the certain explanatory variable is included in the input of the learning model and an output value of the learning model in a case where the certain explanatory variable is not included. Here, the data sample refers to data corresponding to a certain time.

In addition, the sum of the SHAP values of all the explanatory variables of a certain data sample is equal to the difference between an output value of the learning model of the certain data sample and the average value of output values of the learning model of all the data samples.

Therefore, the SHAP value is a value obtained by quantifying the influence of the explanatory variable on the objective variable for each piece of data sample, that is, how much the objective variable changes depending on the presence or absence of the explanatory variable.

Specifically, for example, the SHAP value is expressed by the following Formulas (1) and (2).

The contribution degree calculating unit 150 or 150A calculates the contribution degree on the basis of the difference between expected values of the learning model output values in the presence or absence of the explanatory variable i using the SHAP value.

$${ϕ}_{i} = {\sum }_{S ⊆ N ∖ \{ i \}} \frac{\vert S \vert ! ( n - \vert S \vert - 1 ) !}{n !} [ ν ( S ⋃ \{ i \} ) - v ( S ) ] \qquad ( 1 )$$

$$v ( S ) = \int {dX}_{\overline{S}} \qquad ( 2 )$$

Φi: SHAP value of explanatory variable i.
N: Index set of all explanatory variables
S: Subset of set N that does not include explanatory variable i.
S̅: N\S.
N̅: Index set of monitored data not included in set N.
x_{S}: Monitoring data (explanatory variables) included in set S in factor analysis monitoring data.
X_{S̅}: Monitoring data (explanatory variables) included in set S̅ in factor analysis monitoring data.
x_{N̅}: Monitoring data included in set N̅ in factor analysis monitoring data
v(·): Value function.
f(·): Learning model
In the description, letters with above them are referred to as “. . . bar”. For example, S̅ is described as “S-bar”, N̅ as “N-bar”, X̅ as “X-bar”, X_{S̅} as “X_{S} bar”, and x_{N̅} as “x_{N} bar”.

Term A in Formula (2) indicates the learning model f.

In calculation of v(S) indicated in Formula (2), the input to the learning model f is an explanatory variable selected by the user.

In addition, a probability distribution P (term B of Formula (2)) considering the dependence relationship is always defined on the basis of all the monitoring data including variables other than the explanatory variable.

Therefore, regardless of whether explanatory variables are narrowed down in advance by user determination or explanatory variables are narrowed down in response to an analysis result, the factor analysis can be performed while the dependence relationship between the pieces of monitoring data is accounted for.

That is, it is possible to narrow down factors utilizing user knowledge.

For example, in a case where the number of explanatory variables is five, the relationship between the output value of the learning model and the SHAP value is expressed by the following Formula (3).

Here, “Φ₀” in Formula (3) is an average value of the output values of the learning model, and “x” is all explanatory variables.

$$f ( x ) = {ϕ}_{0} + {\sum }_{i = 1}^{5} {ϕ}_{i} \qquad ( 3 )$$

When the explanatory variable included in the set S is given, the contribution degree calculating unit 150 or 150A defines the probability distribution P (term B of Formula (2)) of the explanatory variable for calculating the value function v(S) on the basis of the causal graph.

It is assumed that the causal graph is given. It may be manually created by the user, or may be estimated from data using a known causal graph estimation method (PC algorithm, GES, LINGAM, or the like), or both may be used. It is assumed that the causal graph is given in the following form.

Here, the causal graph may be stored in advance in, for example, the causal graph storage unit.

The causal graph will be described.

FIG. 4 is a diagram illustrating a first example of the causal relationship data (causal graph) used in the factor analysis device 100 or 100A of the present disclosure.

FIG. 5 is a diagram illustrating a second example of the causal relationship data (causal graph) used in the factor analysis device 100 or 100A of the present disclosure.

FIG. 6 is a diagram illustrating a third example of the causal relationship data (causal graph) used in the factor analysis device 100 or 100A of the present disclosure.

Assume that the causal graph is a directed acyclic graph (DAG) representing a relationship of monitoring data. The causal graph is specified in the form of, for example, a graph, a matrix, a parent-child relationship, or the like.

Graph: It represents the relationship between the monitoring data Xi at the node, the monitoring data Xi and Xj at the arrow, and the relationship from a parent to a child with the start point of the arrow as the monitoring data Xi serving as a parent and the end point as the monitoring data Xj serving as a child. (FIG. 4)

Matrix: The monitoring data Xi of which the row is the parent and the monitoring data Xj of which the column is the child are represented, and in a case where there is a relationship from the parent to the child, an element of i row and j column of the matrix is set to 1, and in a case where there is no relationship, an element is set to 0. (FIG. 5)

Parent-child relationship: A set of monitoring data serving as a parent of the monitoring data Xj serving as a child is represented as pa (Xj), which represents a relationship from the parent to the child. (FIG. 6)

For example, the causal graph is designated as illustrated in FIGS. 4, 5, and 6 for five pieces of monitoring data X1, . . . , X5. Here, FIGS. 4, 5, and 6 all represent the same causal graph.

For example, when a causal graph representing the relationship between the monitoring data is given, the contribution degree calculating unit 150 or 150A expresses the probability distribution P (term B of Formula (2)) of the explanatory variable as the following Formulas (4) and (5).

In the contribution calculating unit, for example, when a causal graph representing the relationship between the monitored data is given, the probability distribution

P(X_{S̅}|x_{S}, x_{N̅}) of the explanatory variables can be expressed as follows.

$$P ( {X}_{\overline{S}} \vert {x}_{s} , {x}_{\overline{N}} ) = {\prod }_{j ∈ S} \qquad ( 4 )$$

$$P ( {X}_{\overline{S}} \vert {x}_{s} , {x}_{\overline{N}} ) = {\prod }_{j ∈ S} \qquad ( 5 )$$

pa(Xⱼ): Explanatory variable that is parent of explanatory variable Xj
D:{xᵢ∈pa(Xⱼ)|i∈S}: Monitoring data (explanatory variables) that is parent of explanatory variable Xj in factor analysis monitoring data and included in set S
E:{Xᵢ∈pa(Xⱼ)|i∈S̅}: Monitoring data (explanatory variables) that is parent of explanatory variable Xj in factor analysis monitoring data and included in set S̅
F:{xᵢ∈pa(Xⱼ)|i∈N̅}: Monitoring data that is parent of explanatory variable Xj in factor analysis monitoring data and included in set N̅

Term C in Formula (4) indicates a relationship between the monitoring data. In the relationship between the monitoring data, the result (child) depends only on the cause (parent). (When a parent is given, the child and other than the parent become independent)

For example, it is assumed that a causal graph is given as follows for five pieces of monitoring data X1, . . . , and X5.

$$\begin{matrix}pa ( X 1 ) & = Φ \\ pa ( X 2 ) & = Φ \\ pa ( X 3 ) & = \{ X 1 , X 2 \} \\ pa ( X 4 ) & = \{ X 2 \} \\ pa ( X 5 ) & = \{ X 3 , X 4 \}\end{matrix}$$

For example, in a case where the objective variable is X5, the explanatory variables X1, X2, and X4, that is, N∈{1, 2, 4} and S∈{1, 4}, the probability distribution P (term B of Formula (2)) can be expressed as follows.

$$P ( {X}_{2} \vert {x}_{1} , {x}_{4} , {x}_{3} , {x}_{5} ) = P ( {X}_{2} ) \qquad ( 6 )$$

For example, in a case where the objective variable is X5, the explanatory variables X1, X2, and X4, that is, N={1, 2, 4} and S∈Φ, P (term B of Formula (2)) can be expressed as follows.

$$P ( {X}_{1} , {X}_{2} , {X}_{4} \vert {x}_{3} , {x}_{5} ) = P ( {X}_{1} ) P ( {X}_{2} ) P ( {X}_{4} \vert {X}_{2} ) \qquad ( 7 )$$

For example, in a case where the objective variable is X5, the explanatory variables X1, X3, and X4, that is, N∈{1, 3, 4} and S∈Φ, P (term B of Formula (2)) can be expressed as follows.

$$P ( {X}_{1} , {X}_{3} , {X}_{4} \vert {x}_{2} , {x}_{5} ) = P ( {X}_{1} ) P ( {X}_{3} \vert {X}_{1} , {x}_{2} ) P ( {X}_{4} \vert {x}_{2} ) \qquad ( 8 )$$

The contribution degree calculating unit 150 or 150A can use, for example, a normal distribution, a Dirichlet distribution, a t distribution, an experience distribution, and the like as the probability distribution P (term B of Formula (2)). In a case where a distribution having parameters is used as the probability distribution, each parameter can be determined using the learning monitoring data. For example, in a case where a normal distribution is used as the probability distribution, an expected value and a variance-covariance matrix can be calculated using the learning monitoring data.

The contribution degree calculating unit 150 or 150A calculates the contribution degree of the explanatory variable i of the nth data sample of the factor analysis monitoring data as Φin, and outputs it to the factor analysis unit 160 or 160A and the factor analysis result output unit 170 or 170A.

The factor analysis unit 160 or 160A acquires and aggregates the contribution degree, and calculates the factor degree.

The factor analysis unit 160 or 160A calculates a factor degree that is a degree of being a factor for each of the explanatory variables on the basis of the contribution degree. The factor degree calculated for each of the explanatory variables can also be said to be a value indicating the degree to which the explanatory variable is a factor that affects the objective variable.

FIG. 7 is a diagram describing the contribution degree output by the contribution degree calculating unit 150 or 150A in the factor analysis device 100 or 100A of the present disclosure.

Specifically, the contribution degree Pin calculated for each data sample of the explanatory variable i is aggregated to calculate the factor degree ci of the explanatory variable i. (FIG. 7)

For example, the average value of the absolute values of Pin can be set as the factor degree ci of the explanatory variable i.

$${C}_{i} = {\sum }_{n} \vert {ϕ}_{in} \vert \qquad ( 9 )$$

The factor analysis unit 160 or 160A outputs the calculated factor degree to the factor analysis result output unit 170 or 170A.

The factor analysis result output unit 170 or 170A outputs a factor analysis result on the basis of the factor analysis data set, the contribution degree, and the factor degree.

The factor analysis result output unit 170 or 170A acquires the factor analysis data set, the contribution degree, and the factor degree, and outputs information regarding the factor analysis result.

FIG. 8 is a diagram illustrating a factor degree output by the factor analysis unit 160 or 160A in the factor analysis device 100 or 100A of the present disclosure.

The factor analysis result output unit 170 or 170A outputs information regarding the factor degree using the factor degree.

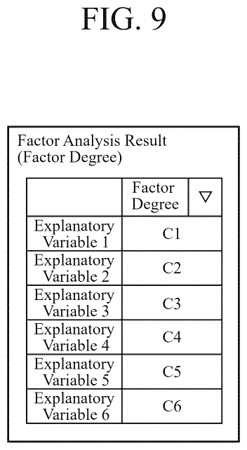

FIG. 9 is a diagram illustrating a first display example of the factor analysis result output by the factor analysis result output unit 170 or 170A in the factor analysis device 100 or 100A of the present disclosure.

FIG. 9 illustrates an example of an output screen regarding the factor degree in a case where the number of explanatory variables is six.

Information indicating the explanatory variable i and information indicating the factor degree ci are displayed. (FIG. 9)

In the initial state, it is assumed that the explanatory variables are displayed in the order in which the explanatory variables are input or in the order stored in advance.

A sort button for sorting the arrangement order in descending order is displayed on the basis of the factor degree.

When the sort button is pressed, sorting is performed in descending order, and the sort button is filled in black.

When the sort button is pressed again, the explanatory variables are rearranged in the input or stored order.

In the initial state, sorting may be performed in descending order of the factor degree. At this time, the sort button is filled in black.

The factor analysis result output unit 170 or 170A outputs information indicating the relationship among the contribution degree, the explanatory variable, and the objective variable using the contribution degree and the factor analysis data set.

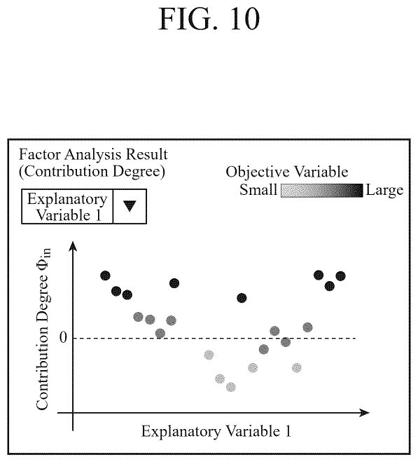

FIG. 10 is a diagram illustrating a second display example of the factor analysis result output by the factor analysis result output unit 170 or 170A in the factor analysis device 100 or 100A of the present disclosure.

FIG. 10 illustrates an example of an output screen illustrating a relationship among the explanatory variable, the contribution degree, and the objective variable with respect to the explanatory variable 1.

A scatter diagram in which the value of the explanatory variable is disposed on the horizontal axis and the contribution degree is disposed on the vertical axis is displayed.

Alternatively, a scatter diagram may be displayed in which the axis of the value of the explanatory variable and the axis of the contribution degree are reversed, and the contribution degree is disposed on the horizontal axis and the value of the explanatory variable is disposed on the vertical axis.

In the scatter diagram, a straight line indicating that the contribution degree is zero is displayed as indicated by a broken line.

In the scatter diagram, one point corresponds to one data sample.

The point concentration indicates a magnitude relationship of the value of the objective variable of the factor analysis data set.

When an expand button is pressed, a list of explanatory variables is displayed, and when an explanatory variable is selected, a scatter diagram corresponding to the selected explanatory variable is displayed.

In a case where the objective variable is discretized data, that is, category data, the shape of the point may be changed instead of the density of the point.

The factor analysis device 100 or 100A may include a control unit, which is not illustrated, and a storage unit, which is not illustrated, in addition to the above configuration.

The control unit, which is not illustrated, controls the entire factor analysis device 100 or 100A. A control unit, which is not illustrated, activates the factor analysis device 100 or 100A or shuts down or puts the factor analysis device 100 or 100A into a sleep state in accordance with, for example, an external command.

The storage unit, which is not illustrated, stores each data used in the factor analysis device 100 or 100A. The storage unit, which is not illustrated, stores, for example, an output (output data) from each component in the factor analysis device 100 or 100A, and outputs data requested for each component to the component of the request source.

The same applies to other embodiments.

A processing example of the factor analysis device 100 or 100A will be described.

The process illustrated in FIG. 3 is a factor analysis method by the factor analysis device 100 or 100A, the factor analysis method including: a data acquiring step of acquiring, by the data acquiring unit 110 or 110A of the factor analysis device 100 or 100A, a plurality of types of monitoring data related to a monitoring target; a variable setting step of generating, by the variable setting unit 120 or 120A of the factor analysis device 100 or 100A, learning monitoring data, factor analysis monitoring data, a learning data set including an explanatory variable and an objective variable, and a factor analysis data set on the basis of the monitoring data; a model learning step of generating, by the model learning unit 130 or 130A of the factor analysis device 100 or 100A, a learning model learned in such a manner as to receive an input of the explanatory variable and output the objective variable on the basis of the learning data set; a causal relationship data acquiring step of acquiring, by the causal relationship data acquiring unit 140 or 140A of the factor analysis device 100 or 100A, causal relationship data indicating a causal relationship in the plurality of types of monitoring data; a contribution degree calculating step of calculating, by the contribution degree calculating unit 150 or 150A of the factor analysis device 100 or 100A, a contribution degree that is a degree of influence of the explanatory variable on the objective variable on the basis of the causal relationship data indicating a causal relationship in the plurality of types of monitoring data, the learning model, the learning monitoring data, and the factor analysis monitoring data; a factor analysis step of calculating, by the factor analysis unit 160 or 160A of the factor analysis device 100 or 100A, a factor degree that is a degree of being a factor for each of the explanatory variables on the basis of the contribution degree; and a factor analysis result output step of outputting, by the factor analysis result output unit 170 or 170A of the factor analysis device 100 or 100A, a factor analysis result on the basis of the factor analysis data set, the contribution degree, and the factor degree.

Note that, in a case where the contribution degree calculating unit 150 or 150A is configured to directly receive a causal graph from the causal graph storage unit, the factor analysis method may include a step of receiving, by the contribution degree calculating unit 150 or 150A, the causal graph from the causal graph storage unit instead of the causal relationship data acquiring step.

When the factor analysis device 100 or 100A starts the processing illustrated in FIG. 3, first, the factor analysis device 100 or 100A executes monitoring data acquisition processing. (Step ST110)

In the monitoring data acquisition processing, the data acquiring unit 110 or 110A of the factor analysis device 100 or 100A acquires a plurality of types of monitoring data related to the monitoring target.

The data acquiring unit 110 or 110A acquires sensor data from the sensor 200 and production management information as monitoring data, and outputs the monitoring data to the variable setting unit 120 or 120A.

Next, the factor analysis device 100 or 100A executes variable setting processing. (Step ST120)

In the variable setting processing, the variable setting unit 120 or 120A of the factor analysis device 100 or 100A generates the learning monitoring data, the factor analysis monitoring data, the learning data set, and the factor analysis data set on the basis of the monitoring data.

The variable setting unit 120 or 120A performs variable setting processing on the monitoring data output from the data acquiring unit 110 or 110A in step ST110, and outputs the learning data set to the model learning unit 130 or 130A, the learning monitoring data and the factor analysis monitoring data to the contribution degree calculating unit 150 or 150A, and the factor analysis data set to the factor analysis result output unit 170 or 170A.

Next, the factor analysis device 100 or 100A executes model learning processing. (Step ST130)

In the model learning processing, the model learning unit 130 or 130A of the factor analysis device 100 or 100A generates a learning model learned in such a manner as to receive an input of the explanatory variable and output the objective variable on the basis of the learning data set.

The model learning unit 130 or 130A performs learning in such a manner as to receive an input of the explanatory variable and output the objective variable with respect to the learning data set output by the variable setting unit 120 or 120A in step ST120, and outputs the learning model to the contribution degree calculating unit 150 or 150A.

Next, the factor analysis device 100 or 100A executes causal relationship data acquisition processing. (Step ST140)

In the causal relationship data acquisition processing, the causal relationship data acquiring unit 140 or 140A of the factor analysis device 100 or 100A acquires causal relationship data indicating a causal relationship in a plurality of types of monitoring data.

Next, the factor analysis device 100 or 100A executes contribution degree calculation processing. (Step ST150)

In the contribution degree calculation processing, the contribution degree calculating unit 150 or 150A of the factor analysis device 100 or 100A calculates a contribution degree, which is a degree of influence of the explanatory variable on the objective variable, on the basis of the causal relationship data indicating the causal relationship in the plurality of types of monitoring data, the learning model, the learning monitoring data, and the factor analysis monitoring data.

The contribution degree calculating unit 150 or 150A acquires a causal graph, performs the contribution degree calculation processing on the learning model output by the model learning unit 130 or 130A in step ST130, the learning monitoring data and the factor analysis monitoring data output by the variable setting unit 120 or 120A in step ST120, and outputs the contribution degree to the factor analysis unit 160 or 160A and the factor analysis result output unit 170 or 170A.

Next, the factor analysis device 100 or 100A executes factor analysis processing. (Step ST160)

In the factor analysis processing, the factor analysis unit 160 or 160A of the factor analysis device 100 or 100A calculates a factor degree, which is a degree of being a factor, for each of the explanatory variables on the basis of the contribution degree.

The factor analysis unit 160 or 160A performs the factor analysis processing on the contribution degree output by the contribution degree calculating unit 150 or 150A in step ST150, and outputs the factor degree to the factor analysis result output unit 170 or 170A.

Next, the factor analysis device 100 or 100A executes factor analysis result output processing. (Step ST170)

In the factor analysis result output processing, the factor analysis result output unit 170 or 170A of the factor analysis device 100 or 100A outputs a factor analysis result on the basis of the factor analysis data set, the contribution degree, and the factor degree.

The factor analysis result output unit 170 or 170A acquires the factor analysis data set output by the variable setting unit 120 or 120A in step ST120, the contribution degree output by the contribution degree calculating unit 150 or 150A in step ST150, and the factor degree output by the factor analysis unit 160 or 160A in step ST160, and presents information regarding the factor analysis result.

Next, the factor analysis device 100 or 100A ends the processing illustrated in FIG. 3.

The factor analysis device of the present disclosure is configured as follows.

A factor analysis device including:
a data acquiring unit to acquire a plurality of types of monitoring data related to a monitoring target;
a variable setting unit to generate learning monitoring data, factor analysis monitoring data, a learning data set including an explanatory variable and an objective variable, and a factor analysis data set on the basis of the monitoring data;
a model learning unit to generate a learning model learned in such a manner as to receive an input of the explanatory variable and output the objective variable on the basis of the learning data set;
a contribution degree calculating unit to calculate a contribution degree that is a degree of influence of the explanatory variable on the objective variable on the basis of causal relationship data indicating a causal relationship in the plurality of types of monitoring data, the learning model, the learning monitoring data, and the factor analysis monitoring data;
a factor analysis unit to calculate a factor degree that is a degree of being a factor for each of the explanatory variables on the basis of the contribution degree; and
a factor analysis result output unit to output a factor analysis result on the basis of the factor analysis data set, the contribution degree, and the factor degree.

Thus, the present disclosure has an effect that a factor analysis device capable of improving the accuracy of factor analysis can be provided.

The factor analysis method of the present disclosure is configured as follows.

A factor analysis method by a factor analysis device, the method including:
a data acquiring step of acquiring, by a data acquiring unit of the factor analysis device, a plurality of types of monitoring data related to a monitoring target;
a variable setting step of generating, by a variable setting unit of the factor analysis device, learning monitoring data, factor analysis monitoring data, a learning data set including an explanatory variable and an objective variable, and a factor analysis data set on the basis of the monitoring data;
a model learning step of generating, by a model learning unit of the factor analysis device, a learning model learned in such a manner as to receive an input of the explanatory variable and output the objective variable on the basis of the learning data set;
a contribution degree calculating step of calculating, by a contribution degree calculating unit of the factor analysis device, a contribution degree that is a degree of influence of the explanatory variable on the objective variable on the basis of causal relationship data indicating a causal relationship in the plurality of types of monitoring data, the learning model, the learning monitoring data, and the factor analysis monitoring data;
a factor analysis step of calculating, by a factor analysis unit of the factor analysis device, a factor degree that is a degree of being a factor for each of the explanatory variables on the basis of the contribution degree; and
a factor analysis result output step of outputting, by a factor analysis result output unit of the factor analysis device, a factor analysis result on the basis of the factor analysis data set, the contribution degree, and the factor degree.

Thus, the present disclosure has an effect that a factor analysis method capable of improving the accuracy of factor analysis can be provided.

The factor analysis system of the present disclosure is configured as follows.

A factor analysis system including:
a sensor;
a data acquiring unit to acquire a plurality of types of monitoring data related to a monitoring target measured by the sensor;
a variable setting unit to generate learning monitoring data, factor analysis monitoring data, a learning data set including an explanatory variable and an objective variable, and a factor analysis data set on the basis of the monitoring data;
a model learning unit to generate a learning model learned in such a manner as to receive an input of the explanatory variable and output the objective variable on the basis of the learning data set;
a contribution degree calculating unit to calculate a contribution degree that is a degree of influence of the explanatory variable on the objective variable on the basis of causal relationship data indicating a causal relationship in the plurality of types of monitoring data, the learning model, the learning monitoring data, and the factor analysis monitoring data;
a factor analysis unit to calculate a factor degree that is a degree of being a factor for each of the explanatory variables on the basis of the contribution degree;
a factor analysis result output unit to output a factor analysis result on the basis of the factor analysis data set, the contribution degree, and the factor degree; and
a display device to display the factor analysis result output by the factor analysis result output unit.

Thus, the present disclosure has an effect that a factor analysis system capable of improving the accuracy of factor analysis can be provided.

The factor analysis program of the present disclosure is configured as follows.

A factor analysis program causing a computer to operate as a factor analysis device including:
a data acquiring unit to acquire a plurality of types of monitoring data related to a monitoring target;
a variable setting unit to generate learning monitoring data, factor analysis monitoring data, a learning data set including an explanatory variable and an objective variable, and a factor analysis data set on the basis of the monitoring data;
a model learning unit to generate a learning model learned in such a manner as to receive an input of the explanatory variable and output the objective variable on the basis of the learning data set;
a contribution degree calculating unit to calculate a contribution degree that is a degree of influence of the explanatory variable on the objective variable on the basis of causal relationship data indicating a causal relationship in the plurality of types of monitoring data, the learning model, the learning monitoring data, and the factor analysis monitoring data;
a factor analysis unit to calculate a factor degree that is a degree of being a factor for each of the explanatory variables on the basis of the contribution degree; and
a factor analysis result output unit to output a factor analysis result on the basis of the factor analysis data set, the contribution degree, and the factor degree.

Thus, the present disclosure has an effect that a factor analysis program capable of improving the accuracy of factor analysis can be provided.

The factor analysis device of the present disclosure is further configured as follows.

In the factor analysis device, furthermore,
the data acquiring unit acquires, as the monitoring data, a plurality of pieces of time-series sensor data collected by a plurality of sensors provided in a monitoring target facility and production management information related to production of the monitoring target facility.

Thus, the present disclosure has an effect that a factor analysis device capable of improving the accuracy of factor analysis related to production facility can be provided.

Furthermore, the present disclosure has an effect similar to the above effect by applying the above configuration to the above factor analysis method, the above factor analysis system, or the above factor analysis program.

The factor analysis device of the present disclosure is further configured as follows.

In the factor analysis device, furthermore,
the contribution degree calculating unit calculates the contribution degree using explainable AI (XAI).

Thus, the present disclosure has an effect that the contribution degree can be calculated using XAI, and thus a factor analysis device capable of further improving the accuracy of factor analysis can be provided.

In addition, the present disclosure has an effect that a factor analysis device that facilitates a user to interpret a factor analysis process can be provided.

Furthermore, the present disclosure has an effect similar to the above effect by applying the above configuration to the above factor analysis method, the above factor analysis system, or the above factor analysis program.

### Second Embodiment

A second embodiment describes a mode that enables reflection of an evaluation result regarding validity of an explanatory variable.

In the description of the second embodiment, contents similar to those already described in the first embodiment may be appropriately omitted.

A configuration example of a factor analysis system including a factor analysis device 100B will be described.

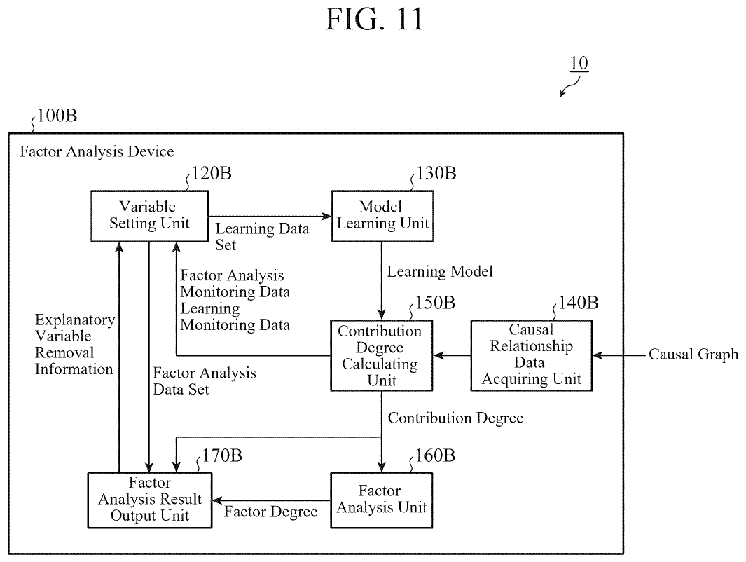

FIG. 11 is a diagram illustrating a configuration example of a factor analysis system 10 including the factor analysis device 100B according to the second embodiment of the present disclosure.

Note that, in FIG. 11, only characteristic configurations of the second embodiment are illustrated with respect to the configuration illustrated in the first embodiment. In the second embodiment, a configuration that is illustrated in the first embodiment and is not illustrated in FIG. 11 may be added.

The factor analysis device of the factor analysis system may receive evaluation regarding validity of an explanatory variable from a user on an output screen regarding a factor degree output by a factor analysis result output unit.

The factor analysis system 10 includes a factor analysis device 100B, a sensor 200, and a display device 300.

The factor analysis device 100B includes a data acquiring unit 110B, a variable setting unit 120B, a model learning unit 130B, a causal relationship data acquiring unit 140B, a contribution degree calculating unit 150B, a factor analysis unit 160B, and a factor analysis result output unit 170B.

In the above configuration, FIG. 11 illustrates the variable setting unit 120B, the model learning unit 130B, the causal relationship data acquiring unit 140B, the contribution degree calculating unit 150B, the factor analysis unit 160B, and the factor analysis result output unit 170B. Hereinafter, contents not described in the above-described embodiment will be mainly described.

The factor analysis result output unit 170B outputs information regarding at least one or more explanatory variables determined to be invalid by the evaluation regarding validity to the variable setting unit 120B as explanatory variable removal information.

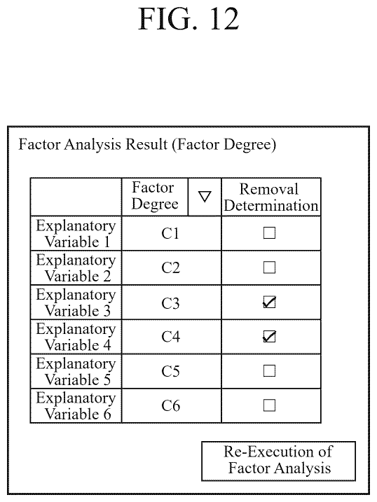

FIG. 12 is a diagram illustrating a display example of the factor analysis result output by the factor analysis result output unit 170B in the factor analysis device 100B according to the second embodiment of the present disclosure.

For example, the factor analysis result output unit 170B provides a check box in a removal determination column of the output screen regarding the factor degree, and receives an input of the user.

For example, the initial state of the check box is an unchecked state. When an input operation (pressing or tapping) is performed in an unchecked state, the check box turns to a checked state. In addition, when an input operation (pressing or tapping) is performed in a checked state, the check box turns to an unchecked state.

For example, the explanatory variable corresponding to the checked check box can be the explanatory variable removal information.

In the drawings, the explanatory variable 3 and the explanatory variable 4 are the explanatory variable removal information.

When re-execution of the factor analysis is pressed in a state where at least one or more is checked, the factor analysis result output unit 170B outputs the explanatory variable removal information to the variable setting unit 120B, and performs processing related to update by evaluation regarding validity by the user.

Using the explanatory variable removal information output by the factor analysis result output unit 170B and information of the monitoring data set to the explanatory variable among the monitoring data, the variable setting unit 120B newly sets monitoring data not included in the “monitoring data included in the explanatory variable removal information” among the “monitoring data set to the explanatory variable” as an explanatory variable after update.

Here, it is assumed that the information of the monitoring data set as the explanatory variable is stored in the variable setting unit 120B.

Hereinafter, the factor analysis device 100B is configured to perform processing similar to that of the first embodiment by replacing the explanatory variable with an explanatory variable after update, acquire a learning model after update, a contribution degree after update, and a factor degree after update, and output information regarding the factor analysis after update.

The processing in the above configuration will be described.

The factor analysis result output unit 170B outputs information regarding at least one or more explanatory variables determined to be invalid by the evaluation regarding validity to the variable setting unit 120B as explanatory variable removal information.

Using the explanatory variable removal information output by the factor analysis result output unit 170B and information of the monitoring data set to the explanatory variable among the monitoring data, the variable setting unit 120B newly sets monitoring data not included in the “monitoring data included in the explanatory variable removal information” in the “monitoring data set to the explanatory variable” as an explanatory variable after update.

Thereafter, in the processing described in the first embodiment, processing similar to that in the first embodiment is performed by replacing the explanatory variable with the explanatory variable after update, the learning model after update, the contribution degree after update, and the factor degree after update are acquired, and information regarding the factor analysis after update is output.

Note that the processing related to update by the evaluation regarding validity by the user may be repeatedly performed.

In the second embodiment, the configuration has been described in which the user evaluates the factor analysis result on the basis of the information regarding the factor analysis output to the display device, examines the factor candidate, removes the factor candidate determined to be unnecessary, and performs the factor analysis processing again. This improves the accuracy of factor analysis.

The factor analysis device of the present disclosure is further configured as follows.

With respect to the factor analysis device of another embodiment,
the factor analysis result output unit receives evaluation regarding validity of the explanatory variable on the basis of the factor analysis result, and
the variable setting unit sets the explanatory variable without using the monitoring data that is the evaluated explanatory variable indicating removal on the basis of a result of the evaluation regarding validity of the explanatory variable.

Thus, the present disclosure further has an effect that a factor analysis device capable of improving the accuracy of factor analysis can be provided.

Furthermore, the present disclosure has an effect similar to the above effect by applying the above configuration to the above factor analysis method, the above factor analysis system, or the above factor analysis program.

### Third Embodiment

A third embodiment describes a mode in which a result satisfying an aggregation condition indicating a condition regarding an objective variable or an explanatory variable can be output.

In the description of the third embodiment, contents similar to those already described in the first embodiment and the second embodiment may be appropriately omitted.

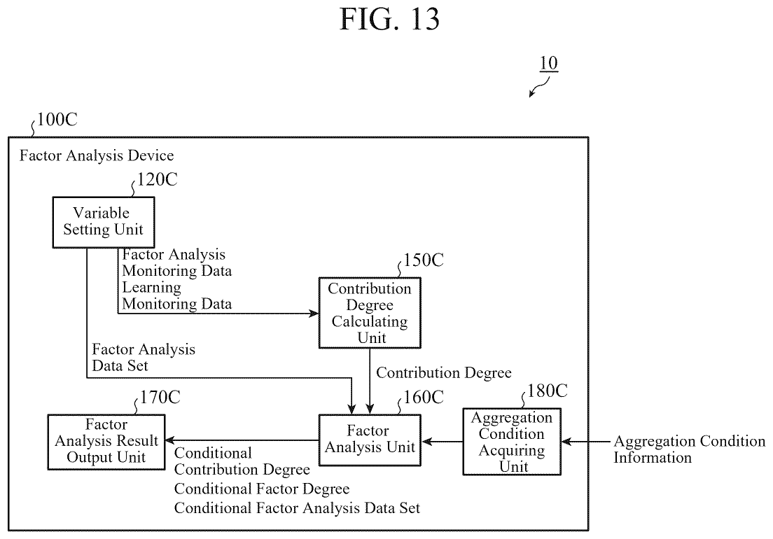

FIG. 13 is a diagram illustrating a configuration example of a factor analysis system 10 including a factor analysis device 100C according to the third embodiment of the present disclosure. Note that, in FIG. 13, only characteristic configurations of the third embodiment are illustrated with respect to the configurations illustrated in the first embodiment and the second embodiment. In the third embodiment, a configuration that is illustrated in the first embodiment and the second embodiment and is not illustrated in FIG. 13 may be added.

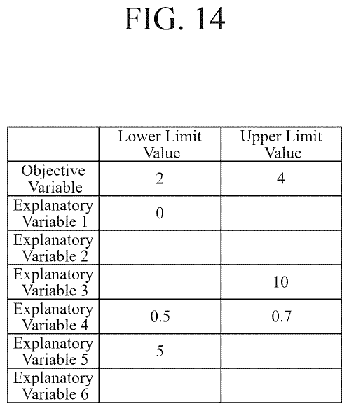

FIG. 14 is a diagram illustrating aggregation conditions used in the factor analysis device 100C according to the third embodiment of the present disclosure.

The factor analysis device 100C may be configured in such a manner that the factor analysis unit 160C calculates a factor degree with respect to a contribution degree satisfying a condition on the basis of aggregation condition information indicating a condition regarding the objective variable and the explanatory variable input by a user.

The factor analysis system 10 includes a factor analysis device 100C, a sensor 200, and a display device 300.

The factor analysis device 100C includes a data acquiring unit 110C, a variable setting unit 120C, a model learning unit 130C, a causal relationship data acquiring unit 140C, a contribution degree calculating unit 150C, a factor analysis unit 160C, a factor analysis result output unit 170C, and an aggregation condition acquiring unit 180C.

In the above configuration, FIG. 13 illustrates the variable setting unit 120C, the contribution degree calculating unit 150C, the factor analysis unit 160C, the factor analysis result output unit 170C, and the aggregation condition acquiring unit 180C. Hereinafter, contents not described in the above-described embodiments will be mainly described.

The aggregation condition acquiring unit 180C acquires an aggregation condition.

The aggregation condition information indicating the aggregation condition can be given, for example, in a format as illustrated in FIG. 14.

The format as illustrated in FIG. 14 is a format in which a lower limit value and an upper limit value are set for each objective variable and explanatory variable.

The factor analysis unit 160C acquires the aggregation condition, and outputs a conditional contribution degree, a conditional factor degree, and a conditional factor analysis data set corresponding to the monitoring data indicated in the aggregation condition in a factor analysis data set in such a manner as to satisfy the aggregation condition.

The factor analysis result output unit 170C outputs a factor analysis result using the conditional contribution degree, the conditional factor degree, and the conditional factor analysis data set output by the factor analysis unit 160C.

A processing example of the factor analysis device 100C will be described.

First, the aggregation condition acquiring unit 180C of the factor analysis device 100C acquires an aggregation condition.

Next, the factor analysis unit 160C acquires the aggregation condition, and outputs the conditional contribution degree, the conditional factor degree, and the conditional factor analysis data set corresponding to the monitoring data indicated in the aggregation condition in the factor analysis data set in such a manner as to satisfy the aggregation condition.

The factor analysis unit 160C of the factor analysis device 100C uses the aggregation condition information acquired by the aggregation condition acquiring unit 180C to calculate the factor degree for the contribution degree satisfying a predetermined condition by a method similar to that in the first embodiment.

For example, a data sample number of the factor analysis data set that is equal to or more than a lower limit value and equal to or less than an upper limit value for each of the objective variable and the explanatory variable is extracted, and the contribution degree satisfying the predetermined condition can be the contribution degree corresponding to the data sample number extracted in all of the objective variable and the explanatory variable. In addition, the factor analysis data set corresponding to the data sample number extracted in all of the objective variable and the explanatory variable can be set as a factor analysis data set satisfying a predetermined condition.

In a case where only the upper limit value or the lower limit value is set, data sample numbers that are equal to or smaller than the upper limit value or equal to or more than the lower limit value are extracted, and when neither the upper limit value nor the lower limit value is set, all data sample numbers are extracted.

For example, as illustrated in FIG. 14, the contribution degree corresponding to the data sample number satisfying all of the following conditions is extracted.

The objective variable is equal to or more than 2 and equal to or less than 4.

The explanatory variable 1 is equal to or more than 0.

The explanatory variable 3 is equal to or less than 10.

The explanatory variable 4 is equal to or more than 0.5 and equal to or less than 0.7

The explanatory variable 5 is equal to or more than 5.

Next, the factor analysis unit 160C acquires the aggregation condition, and outputs the conditional contribution degree, the conditional factor degree, and the conditional factor analysis data set corresponding to the monitoring data indicated in the aggregation condition in the factor analysis data set in such a manner as to satisfy the aggregation condition.

Specifically, the factor analysis unit 160C outputs a factor degree calculated from the contribution degree satisfying the predetermined condition as the conditional factor degree, the contribution degree satisfying the predetermined condition as the conditional contribution degree, a factor analysis data set satisfying a predetermined condition as a conditional factor analysis data set to the factor analysis result output unit 170C.

More specifically, the factor analysis unit 160C performs calculation from the contribution degree satisfying the predetermined condition with respect to the contribution degree output by the contribution degree calculating unit 150C, the factor analysis data set output by the variable setting unit 120C, and the aggregation condition information, and outputs the calculated conditional factor degree, conditional contribution degree, and conditional factor analysis data set to the factor analysis result output unit 170C.

The factor analysis result output unit 170C outputs the factor analysis result using the conditional contribution degree, the conditional factor degree, and the conditional factor analysis data set output by the factor analysis unit 160C.

Specifically, the factor analysis result output unit 170C performs processing similar to that in the first embodiment by replacing the contribution degree with the conditional contribution degree, replacing the factor degree with the conditional factor degree, and replacing the factor analysis data set with the conditional factor analysis data set.

In the third embodiment, the condition is set for the objective variable and the explanatory variable, only the contribution degree under a certain condition is aggregated, and the factor degree is calculated. This further improves the accuracy of factor analysis.

The factor analysis device of the present disclosure is further configured as follows.

With respect to the factor analysis device of another embodiment,
the factor analysis unit
acquires an aggregation condition, and outputs a conditional contribution degree, a conditional factor degree, and a conditional factor analysis data set corresponding to monitoring data indicated by the aggregation condition in the factor analysis data set in such a manner as to satisfy the aggregation condition; and
the factor analysis result output unit
outputs a factor analysis result using the conditional contribution degree, the conditional factor degree, and the conditional factor analysis data set output by the factor analysis unit.

Thus, the present disclosure further has an effect that a factor analysis device capable of improving the accuracy of factor analysis can be provided.

Furthermore, the present disclosure has an effect similar to the above effect by applying the above configuration to the above factor analysis method, the above factor analysis system, or the above factor analysis program.

### Fourth Embodiment

A fourth embodiment will describe a mode in which adaptability of a learning model to monitoring data can be evaluated.

In the description of the fourth embodiment, contents similar to those already described in the first embodiment, the second embodiment, and the third embodiment may be appropriately omitted.

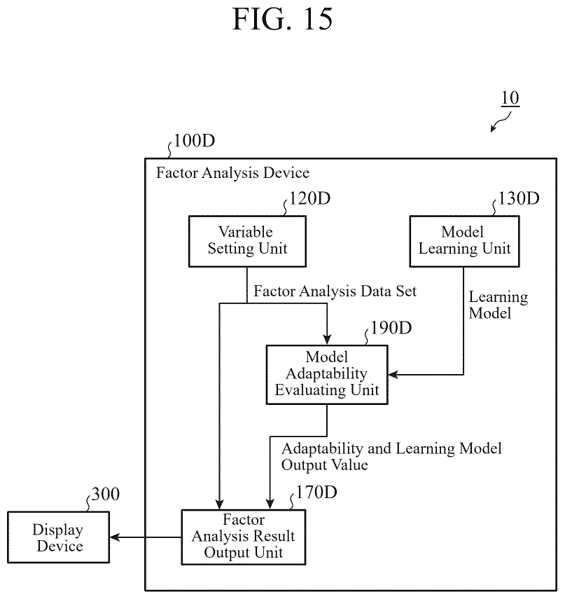

FIG. 15 is a diagram illustrating a configuration example of a factor analysis system 10 including a factor analysis device 100D according to the fourth embodiment of the present disclosure. Note that, in FIG. 15, only characteristic configurations of the fourth embodiment are illustrated with respect to the configurations illustrated in the first embodiment, the second embodiment, and the third embodiment. In the fourth embodiment, a configuration that is illustrated in the first embodiment, the second embodiment, and the third embodiment and is not illustrated in FIG. 15 may be added.

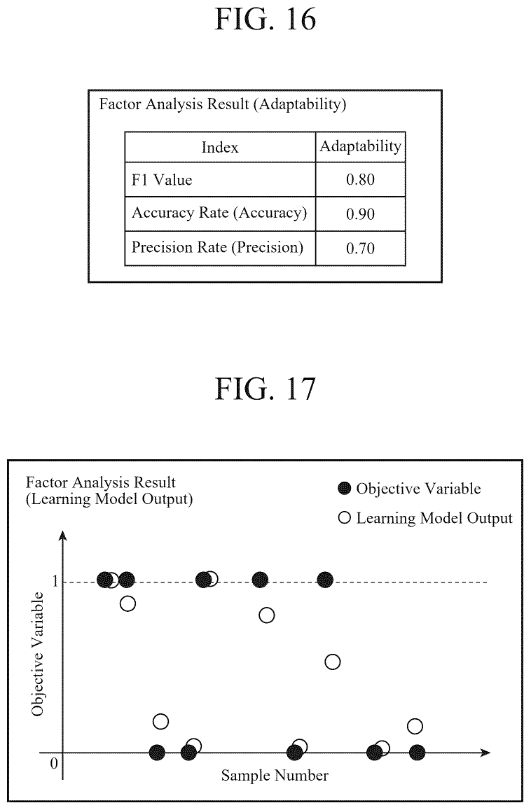

FIG. 16 is a diagram illustrating a first display example of a factor analysis result output by the factor analysis result output unit 170D in the factor analysis device 100D according to the fourth embodiment of the present disclosure.

FIG. 17 is a diagram illustrating a second display example of the factor analysis result output by the factor analysis result output unit 170D in the factor analysis device 100D according to the fourth embodiment of the present disclosure.

The factor analysis system 10 includes a factor analysis device 100D, a sensor 200, and a display device 300.

The factor analysis device 100D may include a model adaptability evaluating unit 190D that evaluates the adaptability of a learning model to the monitoring data.

The factor analysis device 100D includes a data acquiring unit 110D, a variable setting unit 120D, a model learning unit 130D, a causal relationship data acquiring unit 140D, a contribution degree calculating unit 150D, a factor analysis unit 160D, a factor analysis result output unit 170D, an aggregation condition acquiring unit 180D, and a model adaptability evaluating unit 190D.

In the above configuration, FIG. 15 illustrates the variable setting unit 120D, the model learning unit 130D, the factor analysis result output unit 170D, and the model adaptability evaluating unit 190D. Hereinafter, contents not described in the above-described embodiments will be mainly described.

The model adaptability evaluating unit 190D calculates the adaptability of a learning model using a factor analysis data set and the learning model.

The factor analysis result output unit 170D further uses the adaptability calculated by the model adaptability evaluating unit 190D to output a factor analysis result.

A processing example of the factor analysis device 100D will be described.

The model adaptability evaluating unit 190D of the factor analysis device 100D generates a learning model output value that is an output when the explanatory variable of the factor analysis data set is input to the learning model by using the factor analysis data set output by the variable setting unit 120D and the learning model output by the model learning unit 130D.

The model adaptability evaluating unit 190D calculates the adaptability using the generated learning model output value and the objective variable of the factor analysis data set.

The model adaptability evaluating unit 190D outputs the generated learning model output value and the calculated adaptability to the factor analysis result output unit 170D.

The factor analysis result output unit 170D of the factor analysis device 100D outputs information regarding the adaptability using the adaptability output by the model adaptability evaluating unit 190D. In addition, the factor analysis result output unit 170D outputs information regarding a learning model output by using the learning model output value output by the model adaptability evaluating unit 190D and the factor analysis data set output by the variable setting unit 120D.

The model adaptability evaluating unit 190D inputs the explanatory variable of the factor analysis data set to the learning model and generates the learning model output value. The learning model output value is compared with the objective variable of the factor analysis data set to calculate the adaptability.

Here, as the adaptability, at least one or more accuracy evaluation indexes set by the user are used.

In a case where the objective variable is continuous, for example, a mean absolute error (MAE), a mean square error (MSE), a root mean square error (RMSE), a coefficient of determination, or the like can be used.

In a case where the objective variable is binary category data, for example, an accuracy rate (Accuracy), a precision rate (Precision), a recall rate (Recall), an F1 value, and the like can be used.

In a case where the objective variable is ternary or more category data, for example, an accuracy rate (Accuracy), an average F1 value, and the like can be used.

Note that, in a case where the learning data set and the factor analysis data set are equal, the adaptability may be calculated by cross verification. At this time, as the learning model, a learning model newly learned for cross verification is used instead of the learning model output from the model learning unit 130D.

Here, as cross validation, for example, methods of one-out cross validation, k-division cross validation, and layered k-division cross validation can be used.

In a case where two or more adaptabilities are calculated for one accuracy evaluation index by cross verification, one representative value is calculated for one accuracy evaluation index using, for example, an average, a maximum value, a minimum value, a median value, or the like.

The model adaptability evaluating unit 190D outputs the adaptability calculated using the generated learning model output value and at least one or more accuracy evaluation indexes to the factor analysis result output unit 170D.

The factor analysis result output unit 170D outputs information regarding the adaptability using the adaptability output by the model adaptability evaluating unit 190D.

For example, it is assumed that the type of the accuracy evaluation index and the adaptability corresponding to the index are displayed in a tabular form as illustrated in FIG. 16.

FIG. 16 illustrates a case where the objective variable is binary category data and the F1 value, the accuracy rate (Accuracy), and the precision rate (Precision) are selected by the user as the accuracy evaluation index.

The factor analysis result output unit 170D outputs information regarding the learning model output using the learning model output value output by the model adaptability evaluating unit 190D and the factor analysis data set output by the variable setting unit 120D.

For example, as illustrated in FIG. 17, a scatter diagram in which the horizontal axis represents a data sample number of the factor analysis data set, and the vertical axis represents an objective variable and a model output value is displayed. Instead of the scatter diagram, a polygonal line may be displayed.

In FIG. 17, the value of the objective variable is represented by a black circle, and the learning model output value is represented by a white circle.

In the fourth embodiment, a configuration in which the adaptability of the learning model can be evaluated has been described. Thus, the reliability of the factor analysis is improved by determining whether the learning model is good or bad. For example, when the adaptability is poor, the setting of the explanatory variable can be reviewed.

The factor analysis device of the present disclosure is further configured as follows.

With respect to the factor analysis device of another embodiment, the factor analysis device further includes:
a model adaptability evaluating unit to calculate adaptability of the learning model by using the factor analysis data set and the learning model, in which
the factor analysis result output unit
outputs the factor analysis result by further using the adaptability calculated by the model adaptability evaluating unit.

Thus, the present disclosure further has an effect that a factor analysis device capable of improving the reliability of factor analysis can be provided.

Furthermore, the present disclosure has an effect similar to the above effect by applying the above configuration to the above factor analysis method, the above factor analysis system, or the above factor analysis program.

Here, a hardware configuration that implements the functions according to the configuration of the present disclosure described above will be described.

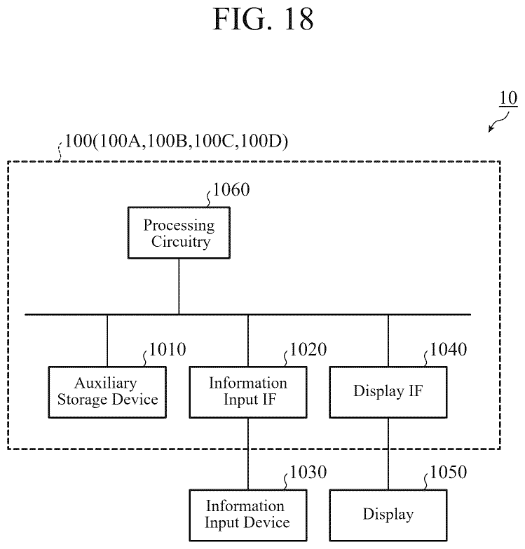

FIG. 18 is a diagram illustrating a first example of a hardware configuration for implementing the functions according to the present disclosure. The hardware configuration illustrated in FIG. 18 implements the functions of the factor analysis devices 100, 100A, 100B, 100C, and 100D.

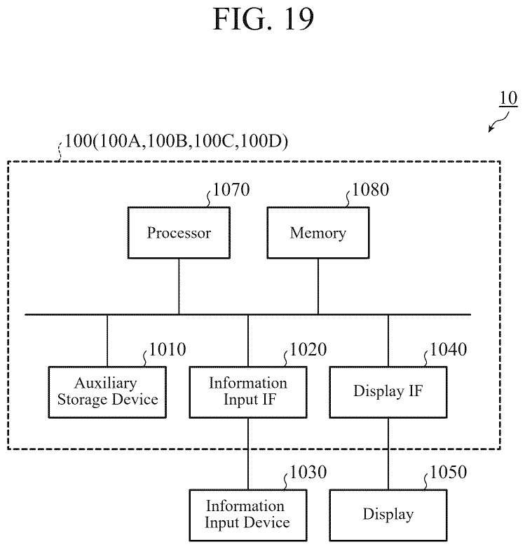

FIG. 19 is a diagram illustrating a second example of a hardware configuration for implementing the functions according to the present disclosure. The hardware configuration illustrated in FIG. 19 executes software that implements the functions of the factor analysis devices 100, 100A, 100B, 100C, and 100D.

An auxiliary storage device 1010 is a storage device having a storage area in which data is read and written. Further, a storage unit that is not illustrated is implemented by the auxiliary storage device 1010 or another memory that is not illustrated.

An information input device 1030 is a device that inputs data to the factor analysis devices 100, 100A, 100B, 100C, and 100D, and is, for example, a touch panel, a mouse, and a keyboard.

Data input using the information input device 1030 is input to the factor analysis device via an information input IF 1020.

A display IF 1040 is an IF that relays data output from the factor analysis devices 100, 100A, 100B, 100C, and 100D to a display 1050.

The display 1050 displays data.

For example, the factor analysis result output units 170, 170A, 170B, 170C, and 170D output results to the display 1050 via the display IF 1040.

The display 1050 displays an estimation result input via the display IF 1040 on the screen.

In a case where the processing circuit is dedicated hardware, a processing circuitry 1060 corresponds to, for example, a single circuit, a composite circuit, a programmed processor, a parallel programmed processor, an application specific integrated circuit (ASIC), a field-programmable gate array (FPGA), or a combination thereof.

The processing circuitry implements the functions of the data acquiring units 110, 110A, 110B, 110C, and 110D, the variable setting units 120, 120A, 120B, 120C, and 120D, the model learning units 130, 130A, 130B, 130C, and 130D, the causal relationship data acquiring units 140, 140A, 140B, 140C, and 140D, the contribution degree calculating units 150, 150A, 150B, 150C, and 150D, the factor analysis units 160, 160A, 160B, 160C, and 160D, the factor analysis result output units 170, 170A, 170B, 170C, and 170D, the aggregation condition acquiring units 180C and 180D, the model adaptability evaluating unit 190D, and a control unit, which is not illustrated, by the hardware as described above.

In a case where the processing circuitry is a processor 1070, the functions of the factor analysis devices 100, 100A, 100B, 100C, and 100D are implemented by software, firmware, or a combination of software and firmware.

The software or firmware is described as a program and stored in a memory 1080.

The processor 1070 implements the functions of the factor analysis devices 100, 100A, 100B, 100C, and 100D by reading and executing the programs stored in the memory 1080.

These programs cause a computer to execute procedures or methods of the functions performed by the factor analysis devices 100, 100A, 100B, 100C, and 100D.

The processor 1070 executes software that implements the functions of the data acquiring units 110, 110A, 110B, 110C, and 110D, the variable setting units 120, 120A, 120B, 120C, and 120D, the model learning units 130, 130A, 130B, 130C, and 130D, the causal relationship data acquiring units 140, 140A, 140B, 140C, and 140D, the contribution degree calculating units 150, 150A, 150B, 150C, and 150D, the factor analysis units 160, 160A, 160B, 160C, and 160D, the factor analysis result output units 170, 170A, 170B, 170C, and 170D, the aggregation condition acquiring units 180C and 180D, the model adaptability evaluating unit 190D, and the control unit, which is not illustrated.

The memory 1080 may be a computer-readable storage medium storing a program for functioning as the factor analysis devices 100, 100A, 100B, 100C, and 100D.

The memory 1080 corresponds to a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, or a DVD.

Note that a part of the functions of the factor analysis devices 100, 100A, 100B, 100C, and 100D may be implemented by dedicated hardware, and a part thereof may be implemented by software or firmware.

The functions of the data acquiring units 110, 110A, 110B, 110C, and 110D, the variable setting units 120, 120A, 120B, 120C, and 120D, the model learning units 130, 130A, 130B, 130C, and 130D, the causal relationship data acquiring units 140, 140A, 140B, 140C, and 140D, the contribution degree calculating units 150, 150A, 150B, 150C, and 150D, the factor analysis units 160, 160A, 160B, 160C, and 160D, the factor analysis result output units 170, 170A, 170B, 170C, and 170D, the aggregation condition acquiring units 180C and 180D, the model adaptability evaluating unit 190D, and the control unit, which is not illustrated, may be implemented by different processing circuits, or may be collectively implemented by a processing circuitry.

Alternatively, some of the functions of the data acquiring units 110, 110A, 110B, 110C, and 110D, the variable setting units 120, 120A, 120B, 120C, and 120D, the model learning units 130, 130A, 130B, 130C, and 130D, the causal relationship data acquiring units 140, 140A, 140B, 140C, and 140D, the contribution degree calculating units 150, 150A, 150B, 150C, and 150D, the factor analysis units 160, 160A, 160B, 160C, and 160D, the factor analysis result output units 170, 170A, 170B, 170C, and 170D, the aggregation condition acquiring units 180C and 180D, the model adaptability evaluating unit 190D, and the control unit, which is not illustrated, may be implemented by a processor 10001 and a memory 10002, and the remaining functions may be implemented by a processing circuitry 20001.

As described above, the processing circuitry can implement each of the above-described functions by hardware, software, firmware, or a combination thereof.

Note that the present disclosure can freely combine each embodiment, modify any component of each embodiment, or omit any component of each embodiment.

### INDUSTRIAL APPLICABILITY

The present disclosure can improve accuracy of factor analysis by calculating a contribution degree for each factor by considering a dependence relationship or a causal relationship between a plurality of factors, and thus the present disclosure is suitable for use in, for example, a factor analysis device, a factor analysis method, a factor analysis system, a factor analysis program, and the like used for factor analysis for production facility.

### REFERENCE SIGNS LIST

10: Factor analysis system, 100, 100A, 100B, 100C, 100D: Factor analysis device, 110, 110A, (110B, 110C, 110D): Data acquiring unit, 120, 120A, 120B, 120C, 120D: Variable setting unit, 130, 130A, 130B, 130C, 130D: Model learning unit, 140, 140A, 140B, (140C, 140D): Causal relationship data acquiring unit, 150, 150A, 150B, 150C, (150D): Contribution degree calculating unit, 160, 160A, 160B, 160C, (160D): Factor analysis unit, 170, 170A, 170B, 170C, 170D: Factor analysis result output unit, 180C, (180D): Aggregation condition acquiring unit, 190D: Model adaptability evaluating unit, 200: Sensor, 300: Display device, 1010: Auxiliary storage device, 1020: Information input interface (information input IF), 1030: Information input device, 1040: Display interface (display IF), 1050: Display, 1060: Processing circuitry, 1070: Processor, 1080: Memory

1. A factor analysis device comprising:
processing circuitry
to acquire a plurality of types of monitoring data related to a monitoring target;
to generate learning monitoring data, factor analysis monitoring data, a learning data set including an explanatory variable and an objective variable, and a factor analysis data set on a basis of the monitoring data;
to generate a learning model learned in such a manner as to receive an input of the explanatory variable and output the objective variable on a basis of the learning data set;
to calculate a contribution degree that is a degree of influence of the explanatory variable on the objective variable on a basis of causal relationship data indicating a causal relationship in the plurality of types of monitoring data, the learning model, the learning monitoring data, and the factor analysis monitoring data;
to calculate a factor degree that is a degree of being a factor for each of the explanatory variables on a basis of the contribution degree; and
to output a factor analysis result on a basis of the factor analysis data set, the contribution degree, and the factor degree.

2. The factor analysis device according to claim 1, wherein
the processing circuitry
acquires, as the monitoring data, a plurality of pieces of time-series sensor data collected by a plurality of sensors provided in a monitoring target facility and production management information related to production of the monitoring target facility.

3. The factor analysis device according to claim 1, wherein
the processing circuitry calculates the contribution degree using explainable AI (XAI).

4. The factor analysis device according to claim 1, wherein
the processing circuitry receives evaluation regarding validity of the explanatory variable on a basis of the factor analysis result, and sets the explanatory variable without using the monitoring data that is the evaluated explanatory variable indicating removal on a basis of a result of the evaluation regarding validity of the explanatory variable.

5. The factor analysis device according to claim 1, wherein
the processing circuitry
acquires an aggregation condition, and outputs a conditional contribution degree, a conditional factor degree, and a conditional factor analysis data set corresponding to monitoring data indicated by the aggregation condition in the factor analysis data set in such a manner as to satisfy the aggregation condition, and
outputs a factor analysis result using the conditional contribution degree, the conditional factor degree, and the conditional factor analysis data set.

6. The factor analysis device according to claim 1, wherein the processing circuitry calculates adaptability of the learning model by using the factor analysis data set and the learning model, and outputs the factor analysis result by further using the adaptability.

7. A factor analysis method performed by a factor analysis device, the method comprising:
acquiring a plurality of types of monitoring data related to a monitoring target;
generating learning monitoring data, factor analysis monitoring data, a learning data set including an explanatory variable and an objective variable, and a factor analysis data set on a basis of the monitoring data;
generating a learning model learned in such a manner as to receive an input of the explanatory variable and output the objective variable on a basis of the learning data set;
calculating a contribution degree that is a degree of influence of the explanatory variable on the objective variable on a basis of causal relationship data indicating a causal relationship in the plurality of types of monitoring data, the learning model, the learning monitoring data, and the factor analysis monitoring data;
calculating a factor degree that is a degree of being a factor for each of the explanatory variables on a basis of the contribution degree; and
outputting a factor analysis result on a basis of the factor analysis data set, the contribution degree, and the factor degree.

8. A non-transitory computer-readable storage medium storing instructions that, when executed by a processor, cause the processor to perform operations comprising:
acquiring a plurality of types of monitoring data related to a monitoring target;
generating learning monitoring data, factor analysis monitoring data, a learning data set including an explanatory variable and an objective variable, and a factor analysis data set on a basis of the monitoring data;
generating a learning model learned in such a manner as to receive an input of the explanatory variable and output the objective variable on a basis of the learning data set;
calculating a contribution degree that is a degree of influence of the explanatory variable on the objective variable on a basis of causal relationship data indicating a causal relationship in the plurality of types of monitoring data, the learning model, the learning monitoring data, and the factor analysis monitoring data;
calculating a factor degree that is a degree of being a factor for each of the explanatory variables on a basis of the contribution degree; and
outputting a factor analysis result on a basis of the factor analysis data set, the contribution degree, and the factor degree.
